(19) United States
(12) Patent Application Publication
(10) Pub. No.: US 2014/0006311 A1
(43) Pub. Date: Jan. 2, 2014

(54) Regional Equity Index

(71) Applicants: Lars Hamich, Frankfurt (DE); Jan F. van Eck, Rye, NY (US)

(72) Inventors: Lars Hamich, Frankfurt (DE); Jan F. van Eck, Rye, NY (US)

(21) Appl. No.: 13/534,689

(22) Filed: Jun. 27, 2012

(51) Int. Cl. G06Q 40/06

(52) U.S. Cl. 705/36 R

(57) ABSTRACT

In a computer-implemented method, financial data associated with a plurality of companies is stored, where the financial data identifies a country of operation and a market capitalization value. A determination is made as to whether a particular one of the companies does more than a threshold amount of business in a geographic region using the financial data. Using historical trading data for the particular company, a determination is made as to whether the particular company meets a liquidity threshold. The particular company is selected for the index when the company does more than the threshold amount of business in the region and meets the liquidity threshold. A weight is assigned to the particular company and other selected companies based on market capitalizations from the financial data. An identification of the selected particular company and the other selected companies and the assigned weights are stored in a non-transitory computer-readable medium.

### TECHNICAL FIELD

The technology described in this patent document relates generally to financial services and investment and more particularly to systems and methods for generating an equity index associated with a particular geographic region.

### BACKGROUND

An equity index is a collection of publicly-traded companies used to measure a section of the stock market. For example, a “world” or “global” equity index (e.g., MSCI World, S&P Global 100) may include a collection of large companies from various locations around the world and may reflect the state of the global economy. A regional index is a particular type of equity index that contains only companies associated with a specific geographical area (e.g., a particular country, region of a country, or continent). Regional indices may reflect the performance of the stock market of the specific geographical area and may thus be used to indicate investor sentiment on the state of the area's economy. Investing in regional indices may allow an investor to increase his or her portfolio's diversification by being exposed to foreign geographical areas. Further, investing in regional indices may allow investors to take advantage of the economic growth of a particular region. For example, regions undergoing significant infrastructure growth and modernization may be seen as good candidate regions in which to invest.

### SUMMARY

The present disclosure is directed to systems and methods for generating an equity index associated with a particular geographic region. In a computer-implemented method for generating an equity index associated with a particular geographic region, financial data associated with a plurality of companies is stored, where the financial data identifies a country of operation and a market capitalization value. A determination is made as to whether a particular one of the companies does more than a threshold amount of business in the particular geographic region using the financial data. Using historical trading data for the particular company, a determination is made as to whether the particular company meets a predefined liquidity threshold. The particular company is selected for the index when the company does more than the threshold amount of business in the particular geographic region and the company meets the predefined liquidity threshold. A weight is assigned to the selected particular company and other selected companies based on market capitalizations from the financial data. An identification of the selected particular company and the other selected companies and the assigned weights are stored in a non-transitory computer-readable medium.

The present disclosure is also directed to a system for generating an equity index associated with a particular geographic region. The system includes one or more data processors and one or more non-transitory computer-readable mediums responsive to the one or more data processors. The one or more computer-readable mediums include a financial data store, where the financial data store is configured to store financial data records associated with a plurality of companies according to a financial data store data structure. The financial data store data structure includes a company identification field, a market capitalization field, and a country of operation field. The one or more computer-readable mediums also include an index data store, where the index data store is configured to store index data records associated with companies selected for inclusion in an index. The companies selected for inclusion in the index do more than a threshold amount of business in a particular geographic region, as determined by the financial data records, and meet a predefined liquidity threshold. The index data records store data according to an index data structure that includes a company identification field, an index identification field, and an index weight field. A particular index weight is based on a market capitalization of a particular company and a total market capitalization of all companies in the index.

### BRIEF DESCRIPTION OF THE FIGURES

FIG. 1 depicts an example system for generating a regional equity index.

FIG. 2 depicts another example system for generating a regional equity index.

FIG. 3 is a flowchart depicting a series of filters used to generate an index for a particular region.

FIG. 4 is a flowchart illustrating an example method for generating an equity index associated with a particular geographic region.

FIG. 5 is a flowchart illustrating another example method for generating an equity index associated with a particular geographic region.

FIG. 6 is a flowchart illustrating an example reevaluation method for determining whether a particular company should continue to remain in an equity index associated with a particular geographic region.

FIG. 7 is a flowchart illustrating an initial public offering (IPO) fast track method for adding companies to an equity index associated with a particular geographic region.

FIG. 8 is a flowchart illustrating a method used to determine whether a particular company should be deleted immediately from a regional index.

FIG. 9 is a flowchart depicting a method of assigning weights to companies selected for an index.

FIG. 10 depicts data structures used in a system for generating an equity index associated with a particular geographic region.

FIGS. 11A, 11B, and 11C depict example systems for use in implementing an equity index generation system.

### DETAILED DESCRIPTION

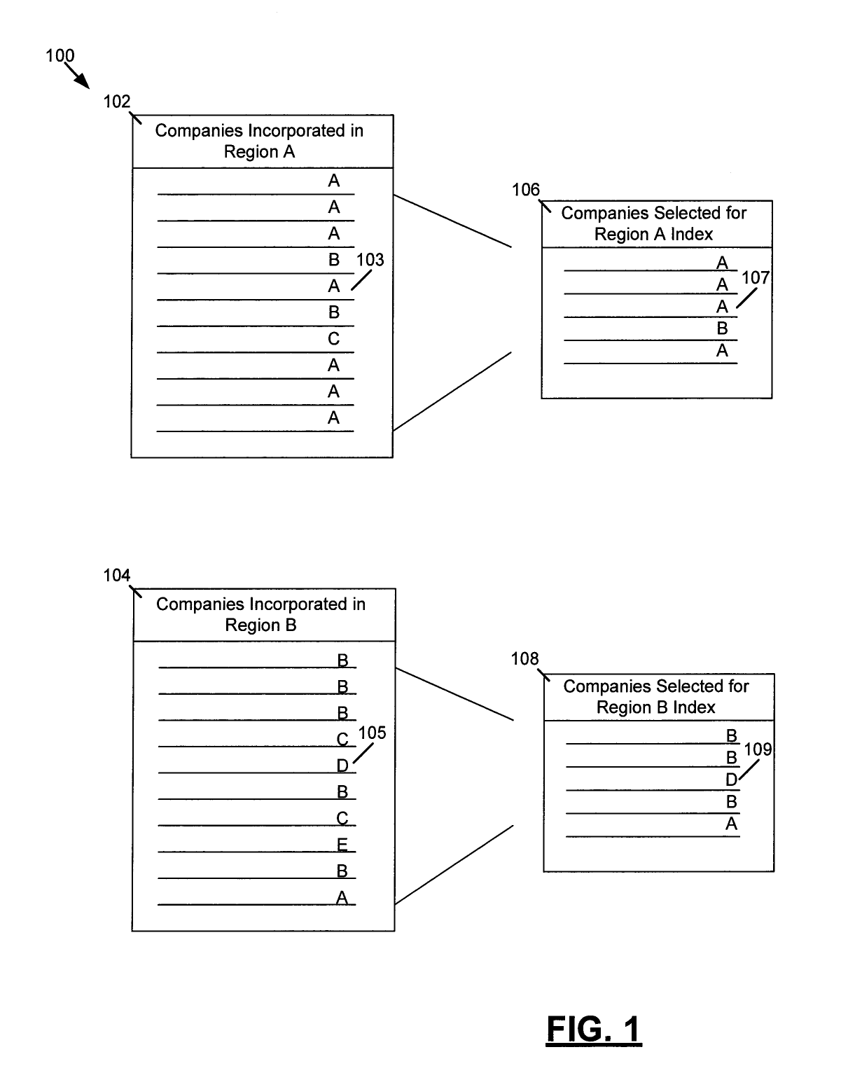

FIG. 1 depicts an example system 100 for generating a regional equity index. In FIG. 1, first and second tables 102, 104 may each include financial data associated with a plurality of companies. The first table 102 may include financial data for companies that are incorporated in Region A, and the second table 104 may include financial data for companies that are incorporated in Region B. The financial data of the tables 102, 104 may be stored, for example, within data structures (e.g., data tables) of a database. The financial data of the tables 102, 104 may include a region of operation (e.g., a country, continent, or state) 103, 105 and various other information about each of the plurality of companies (e.g., an identifying symbol, historical stock market data, information about each company's revenues, costs, profitability, and/or cash flow). The region of operation data 103, 105 may be determined for each of the listed companies using a variety of metrics. In one example, the region of operation data 103, 105 may be determined based on where each of the listed companies generates at least 50% of their revenues. In another example, the region of operation data 103, 105 may be determined based on where each of the companies is listed for trading, is organized or incorporated, and/or owns property.

The tables 102, 104 may be used as initial investment universes from which regional equity indices 106, 108 may be generated, respectively. In the example of FIG. 1, the first regional equity index 106 may include a listing of companies selected for a Region A index, where each of the selected companies is selected from the first table 102. Thus, in the Region A index 106, all companies selected are incorporated or otherwise organized in Region A and are listed for trading in Region A (e.g., domiciled and listed for trading Region A). Similarly, the second regional equity index 108 may include a listing of companies selected for a Region B index, where all of the selected companies are from the second table 104 and thus represent companies that are incorporated in Region B. Each of the indices 106, 108 may include associated financial data for each of the selected companies, which may include a region of operation 107, 109 for each of the selected companies and other associated data.

As illustrated in the Region A and B indices 106, 108 of FIG. 1, the companies selected for each of the respective indices may include companies that have different regions of operation 107, 109. For example, as illustrated in the Region B index 108, although all companies were selected from the table 104 including companies incorporated in Region B, these selected companies may nevertheless operate in various different regions A, B, and D. Although the system of FIG. 1 may be a relatively simple and convenient method of selecting stocks associated with a particular geographical region, this method may be both overinclusive and underinclusive. Such overinclusiveness and underclusiveness may diminish the potential benefits of a regional index (e.g., diversification, leveraging of economic growth in a region).

For example, in the Region A index 106, the inclusion of a company with a region of operation of Region B may be overinclusive. The company with region of operation of Region B, although incorporated in Region A, may in reality have no or little significant connection to Region A. A company may be incorporated in a particular region for a variety of reasons (e.g., tax-related reasons), but these reasons may not be sufficient to produce a significant connection to the region of incorporation. Similarly, selecting stocks for a regional index in accordance with the method presented in FIG. 1 may also be underinclusive. For example, in the Region B index 108, the failure to select various companies with a region of operation of Region B from the data table 104 may represent a lost opportunity in creating an index of companies with significant connections to Region B.

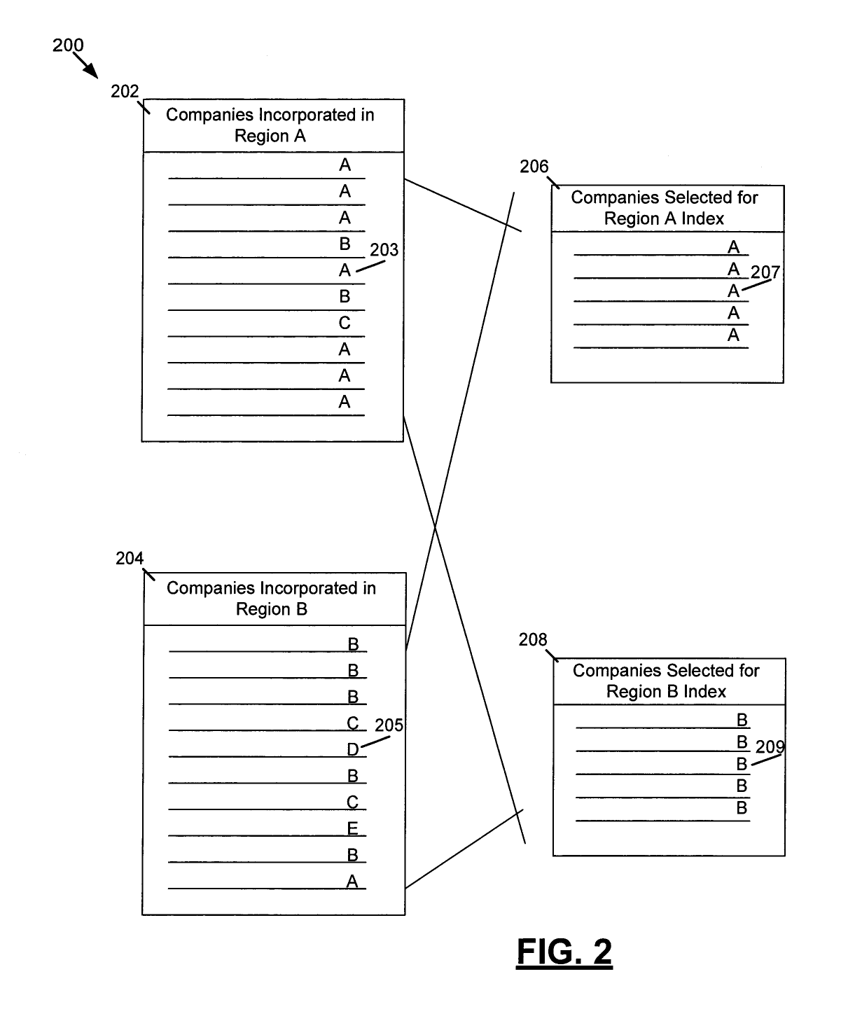

FIG. 2 depicts another example system 200 for generating a regional equity index. Similar to FIG. 1, first and second tables 202, 204 may each include financial data associated with a plurality of companies. The first table 202 may include financial data for companies that are incorporated in Region A, and the second table 204 may include financial data for companies that are incorporated in Region B. The financial data for the tables 202, 204 may be stored within data structures (e.g., data tables) of a database. As in the example of FIG. 1, the financial data of the tables 202, 204 may include a region of operation 203, 205 and various other financial information about each of the plurality of listed companies (e.g., an identifying symbol, historical stock market data, information about each company's revenues, costs, profitability, and/or cash flow).

The tables 202, 204 may be used as initial investment universes from which regional equity indices 206, 208 may be generated. Contrary to the example of FIG. 1, however, in FIG. 2, regional indices 206, 208 may each be generated by selecting companies from both tables 202, 204. In further contrast to FIG. 1, companies for the Region A and B indices 206, 208 of FIG. 2 may be selected based on the region of operation fields 203, 205 of the tables 202, 204. Thus, in the example of FIG. 2, the Region A equity index 206 may include only companies with a region of operation of Region A, as illustrated at 207. Similarly, the Region B equity index 208 may include only companies with a region of operation of Region B, as illustrated at 209.

FIG. 2's system of creating Region A and B indices may overcome the overinclusiveness and underinclusiveness problems noted above for the example of FIG. 1 and may allow the potential benefits of a regional index to be realized. In the example system of FIG. 2, companies that are merely incorporated in a particular region may not necessarily be included in an index associated with the particular region. Further, by employing various filters and thresholds within the context of the system presented in FIG. 2, one can further ensure that the companies included in a regional index have significant connections to the region. For example, merely operating in a particular region may be insufficient to be included in an index for the particular region, and instead, it may be required that a company does more than a threshold amount of business in the particular region (e.g., 50%). Thus, companies that have only tangential or insignificant relationships to the region may not be included in the index associated with the region, and this may help to ensure that the potential benefits of investing in a regional index are achieved by investors.

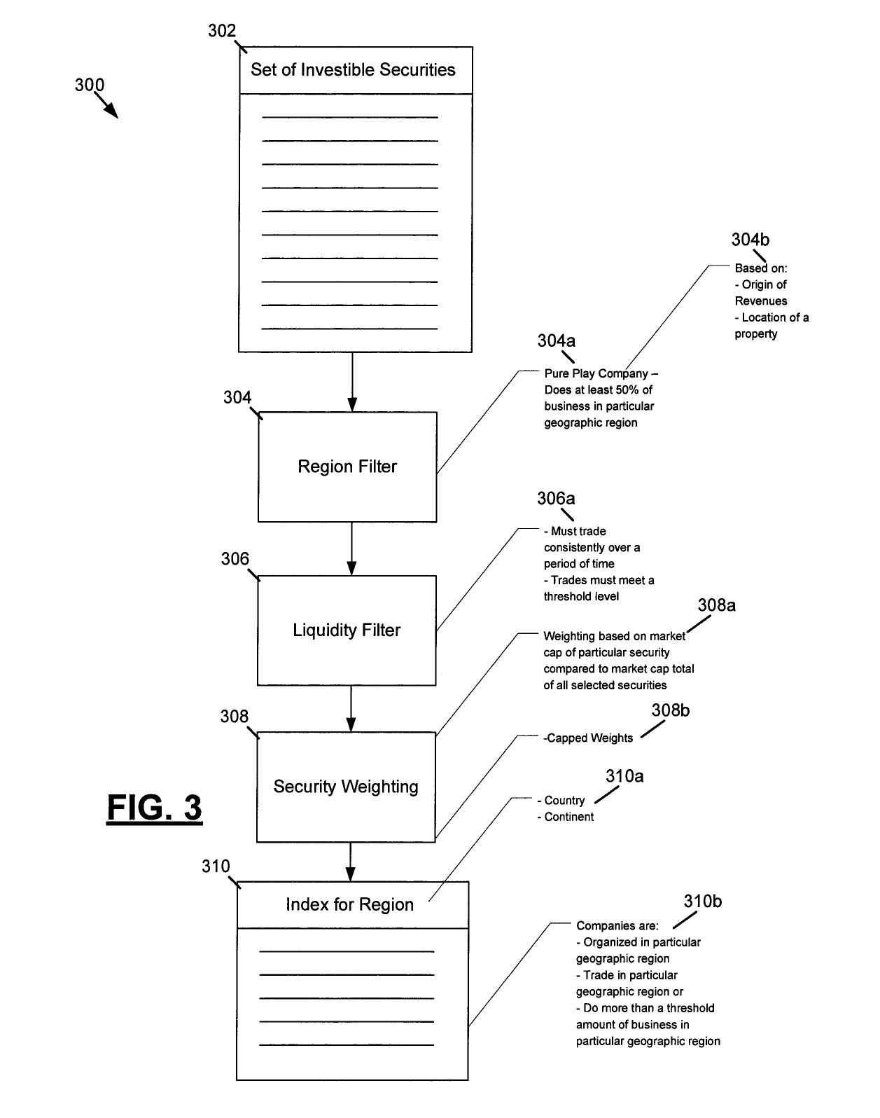

FIG. 3 is a flowchart 300 depicting a series of filters 304, 306, 308 used to generate an index for a particular region 310. In FIG. 3, a process of generating the index for the particular region 310 may begin with a set of investible securities 302, which may represent an initial investment universe from which the index 310 is generated. From the set of investible securities 302, filters 304, 306, 308 may be applied to filter out certain securities and ultimately produce the index for the region 310. The investible securities to include in the set of investible securities 302 may be generated using a number of different methods. In one example, the set of investible securities 302 may include (I) securities from companies that are locally listed or incorporated in the particular region; (II) securities from offshore companies from any part of the world that are incorporated outside the region but that generate at least 50% of their revenues in the particular region; and (III) American Depository Receipts (ADRs) and Global Depository Receipts (GDRs) of companies that are incorporated in the particular region. The set of investible securities 302 may be limited to only common stocks or stocks with similar characteristics that are freely investible to foreign investors and that provide real-time and historical component pricing.

Region filter 304 may be first applied to the securities of the set of investible securities 302. Region filter 304 may be used, generally, to filter out securities associated with companies that do not carry out significant operations in the particular region. As noted above, generating regional indices comprised solely of companies that have a region of operation within the particular region may be a means of realizing the benefits of diversification associated with regional indexing. Region filter 304 may be based on a particular quantitative measure 304a that requires that a company passing through the filter 304 do at least 50% of its business in the particular region. The particular percentage of business that must be done in the region may be varied, depending on the particular degree of association to the region desired. The quantitative measure 304a may thus target pure play companies that do a majority of their business in the region. The determination of whether a company does at least 50% of its business in the particular region 304a may be based on, for example, the company's origin of revenues and/or location of property 304b.

Liquidity filter 306 may be employed following the region filter 304, as illustrated in the example of FIG. 3. The liquidity filter 306 may be used to further filter out securities from the set of investible securities 302. To meet the requirements of the liquidity filter 306, securities for a company may be required to trade consistently over a period of time, and/or trades for the company's securities may be required to meet a particular threshold level 306a. Further, in one example, the liquidity filter 306 may also require that a company have no more than ten non-trading days in a three-month period. In another example, the liquidity filter may also require that a company be associated with stock that is tradable by foreign investors. In yet another example, the liquidity filter may require that real-time and historic pricing be available for a security associated with a company. Similar to the particular measures 304a, 304b employed for the region filter 304, the measures 306a of the liquidity filter 306 may be varied and controlled based on the particular goals of one creating the index 310.

Security weighting filter 308 may be employed following the liquidity filter 306, as illustrated in the example of FIG. 3. The security weighting filter 308 may be employed not to prevent securities from being placed in the regional index 310, but rather to assign a weight to each of the securities that have passed through the region and liquidity filters 304, 306. After assigning the weight to each of the securities, a ranked set of weighted securities may be placed in the regional index 310. A weighting process applied by the security weighting filter 308 may be based on a weighting criteria 308a. Weighting criteria 308a may be based on a free-float market capitalization of a particular security compared to a market capitalization of all securities that have passed through the region and liquidity filters 304, 306. Thus, the weighting criteria 308a may be based on the particular security's proportion of the total market capitalization of all securities entering the security weighting filter 308.

Following an initial weighting based on the free-float market capitalization method of weighting criteria 308a, weight limitations (i.e., caps) may be applied to limit a weight assigned to a particular security. Thus, the output of the security weighting filter 308 may be the securities that have passed through the region and liquidity filters 304, 306 with capped weights 308b. In one example, the capped weights 308b can be determined based on the following criteria: a maximum 8.0% weight for any single company; when market capitalization of each of a largest two companies exceed 8.0% of total market capitalization of all companies of the index, weights for the largest two companies are capped at 8.0%; when third largest company exceeds 7.0%, a weight for the third largest company is capped at 7.0%; when fourth largest company exceeds 6.5%, a weight for the fourth largest company is capped at 6.5%; when fifth largest company exceeds 6.0%, a weight for the fifth largest company is capped at 7.0%; when sixth largest company exceeds 5.5%, a weight for the sixth largest company is capped at 7.0%; when seventh largest company exceeds 5.0%, a weight for the seventh largest company is capped at 7.0%; when any other company exceeds 4.5%, a weight for the any other company is capped at 4.5%; any excess weight is re-distributed proportionally to remaining companies; and any company that is incorporated or listed for trading outside of the particular geographic region is capped at 4.5%. The criteria used to determine the capped weights 308b may be varied as needed to accomplish one's objectives in creating the index 310.

The end result of the filtering process may be the index for the particular region 310 including a listing of companies with capped weights. In one example, at least twenty companies may be selected for the index 310. The particular region for the index 310 may be a country, continent, or other geographical region 310a. Although example criteria 304a of the region filter 304 may target companies that do more than a threshold amount of business in the particular region, in other examples, different filtering criteria may be used such that the companies of the index 310 may be those that are organized in the region and/or trade in the particular region, as illustrated at 310b. After generating the index 310, shares may be purchased for the companies selected for the index and an offer to sell shares of the index for an index price that is based on prices of the shares of the selected companies may be made. Money may be received for purchase of a share of the index and the share of the index may be transferred in exchange for the received money.

Various other filtering schemes may be employed. Although the example of FIG. 3 depicts the region filter 304, liquidity filter 306, and security weighting filter 308 arranged serially in a particular order, other filtering schemes may change the order, employ a parallel filtering process, and/or employ other filters. In one example, an additional filter may be applied to the set of investible securities 302, such that a company may be excluded from the index despite meeting the amount of business 304a and predefined liquidity threshold 306a. The additional filter may be, for example, a filter that requires a predefined free-float market capitalization minimum (e.g., a predefined free-float market capitalization minimum of at least 10%).

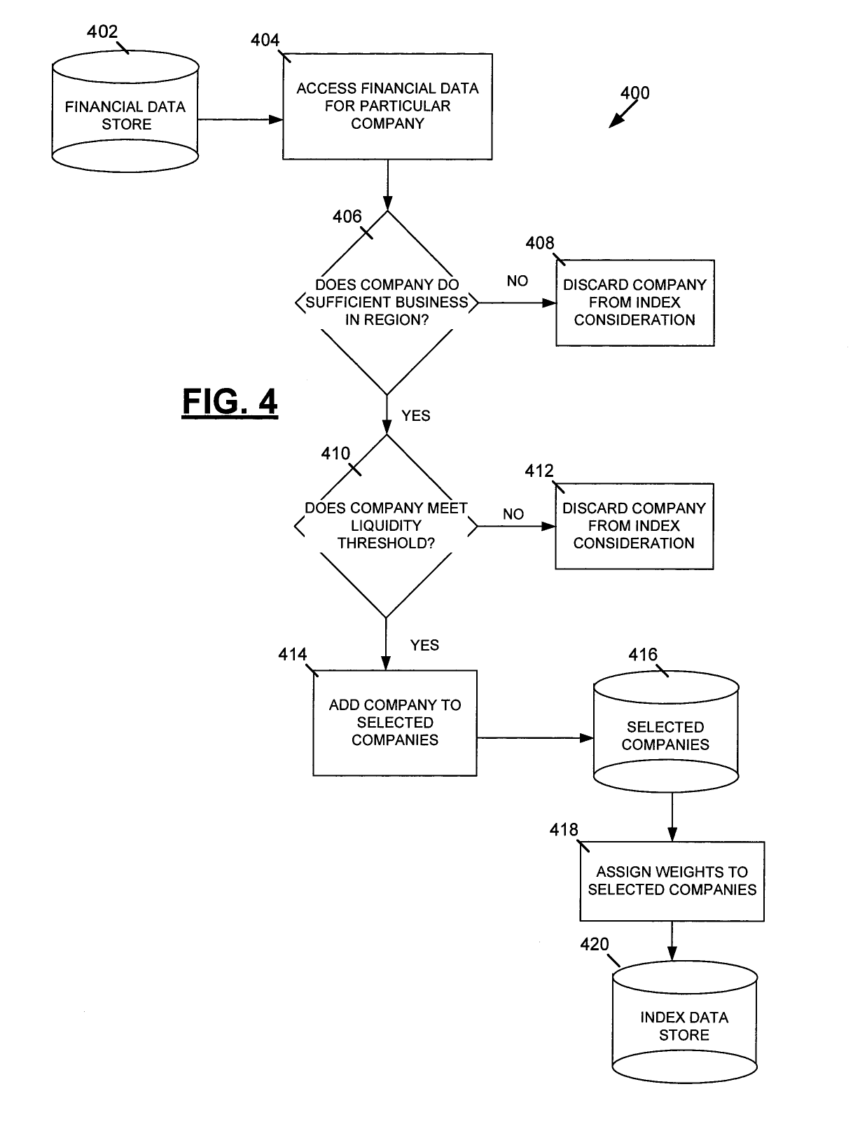

FIG. 4 is a flowchart 400 illustrating an example method for generating an equity index associated with a particular geographic region. A financial data store 402 may store financial data associated with a plurality of companies. The financial data stored in the financial data store 402 may identify a country of operation and a market capitalization value for each of the plurality of companies. At 404, financial data for a particular company may be accessed from the data store 402 in order to evaluate the particular company for inclusion in the index. At 406, using the accessed financial data, a determination may be made as to whether the particular company does more than a threshold amount of business in the particular geographic region. At 408, if the particular company does not do the threshold amount of business in the particular geographic region, the particular company may be discarded from index consideration. At 410, if the particular company does the threshold amount of business in the particular geographic region, a determination may be made as to whether the particular company meets a predefined liquidity threshold. The determination at 410 may be made using historical trading data for the particular company. If the particular company does not meet the predefined liquidity threshold, the particular company may be discarded from index consideration at 412. If the particular company does meet the predefined liquidity threshold, the particular company may be selected for the index at 414. The selected particular company may be placed in a data store 416 containing information on selected companies. At 418, a weight may be assigned to the selected particular company and other selected companies of the data store 416 based on market capitalizations from the financial data. An identification of the selected particular company and the other selected companies of the data store 416 and the assigned weights may be stored in a non-transitory computer-readable medium data store 420.

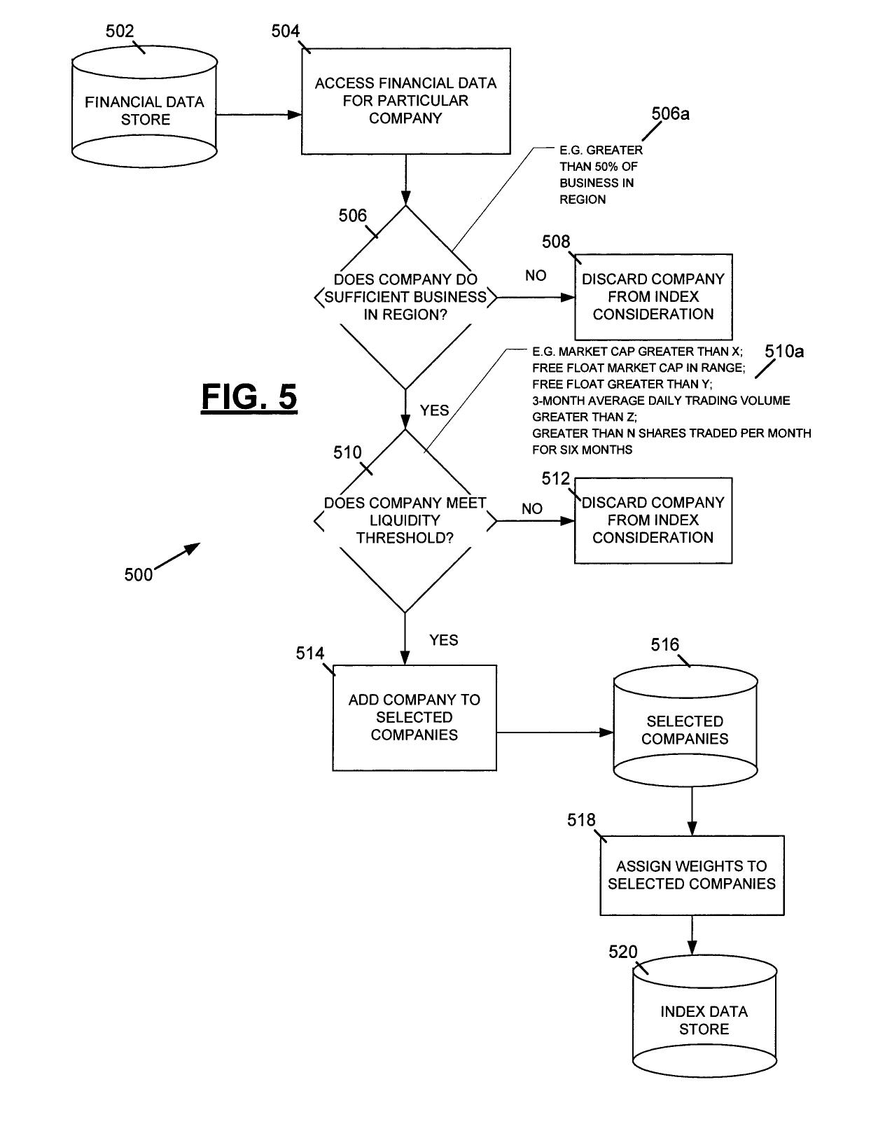

FIG. 5 is a flowchart 500 illustrating another example method for generating an equity index associated with a particular geographic region. A financial data store 502 may store financial data associated with a plurality of companies. The plurality of companies for which financial data is stored may comprise an initial investment universe from which the equity index is generated. The initial investment universe may include (I) securities from companies that are locally listed or incorporated in a particular country or region; (II) securities from offshore companies from any part of the world that are incorporated outside the particular country or region but generate at least 50% of their revenues in the particular country or region; and (III) all ADRs and GDRs of companies that are incorporated in the particular country or region. Further, securities of the initial investment universe may be limited to only common stocks or stocks with similar characteristics that are freely investible to foreign investors and that provide real-time and historical component pricing. The financial data stored for these companies in the financial data store 502 may identify a country of operation and a market capitalization value for each of the plurality of companies.

At 504, financial data for the particular company may be accessed from the financial data store 502, and at 506, a determination may be made as to whether the particular company does more than a threshold amount of business in the particular geographic region. The threshold amount of business may require, for example, that the particular company does more than 50% of its business in the particular geographic region 506a. If the particular company does not do the threshold amount of business in the particular geographic region, the particular company may be discarded from index consideration at 508.

If the particular company does the threshold amount of business in the particular geographic region, a determination may be made as to whether the particular company meets a predefined liquidity threshold at 510. The predefined liquidity threshold may be based on, for example, liquidity criteria factors 510a: whether the particular company's market capitalization is greater than a threshold value (e.g., $150 million U.S. dollars); whether the particular company's free-float market capitalization is in a particular free-float market capitalization range (e.g., within a 0% to 85% free-float market capitalization range); whether the particular company's free-float average is greater than a threshold value (e.g., greater than or equal to 10%); whether the particular company has a 3-month average daily trading volume greater than a threshold value (e.g., $1 million U.S. dollars for this and the previous two quarters); and whether the particular company has greater than a threshold value of shares traded per month for six months (e.g., 250,000 shares).

The liquidity threshold may be based on any combination of the criteria factors 510a, and in one example, all of the individual factors must be satisfied in order for the liquidity threshold to be met. In addition to the criteria factors 510a illustrated in FIG. 5, the criteria factors 510a may further require that the particular company have no more than ten non-trading days in a three-month period. In another example, the liquidity filter may also require that a company be associated with stock that is tradable by foreign investors. In yet another example, the liquidity filter may require that real-time and historic pricing be available for a security associated with the particular company. The determination at 510 as to the liquidity threshold may be made using historical data for the particular company.

If the particular company does not meet the predefined liquidity threshold, the particular company may be discarded from index consideration at 512. If the particular company does meet the predefined liquidity threshold, the particular company may be selected for the index at 514. The selected particular company may be placed in a data store 516 containing information on selected companies. At 518, a weight may be assigned to the selected particular company and other selected companies of the data store 516 based on market capitalizations from the financial data of the companies. An identification of the selected particular company and the other selected companies of the data store 516 and the assigned weights may be stored in a non-transitory computer-readable medium data store 520.

A value for the index created pursuant to the example method of FIG. 5 may be calculated according to the following equation:

Index Value=Σ_{i=1 to n}pᵢ×qᵢ×ffᵢ×fxᵢ×cfᵢ

where pᵢ is a stock price for a company in the index, qᵢ is a number of shares in the index, ff₁ is a free-float factor for a company in the index, fxᵢ is an exchange rate, and cf₁ is a weighting cap factor.

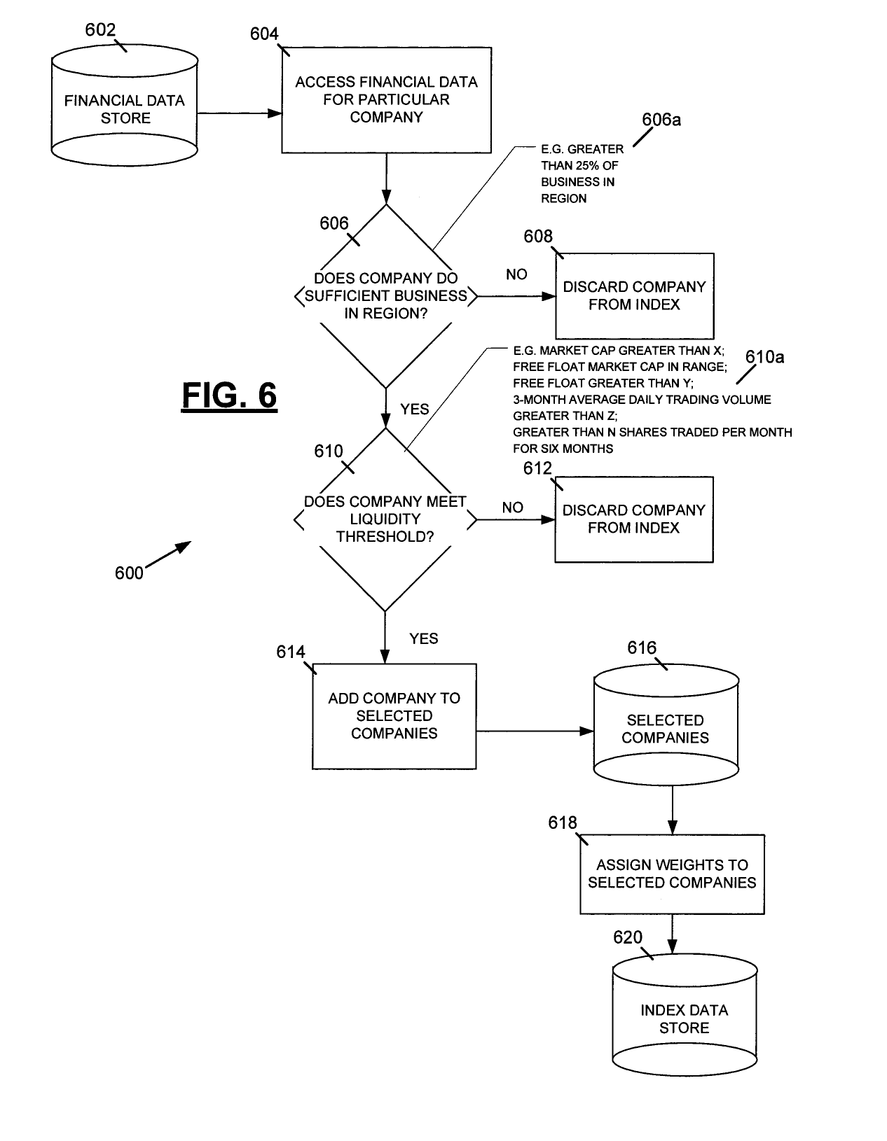

FIG. 6 is a flowchart 600 illustrating an example reevaluation method for determining whether a particular company should continue to remain in an equity index associated with a particular geographic region. Flowcharts 400 and 500 of FIGS. 4 and 5, respectively, depict example methods for determining whether a particular company should be added to an equity index associated with a particular region. By contrast, flowchart 600 of FIG. 6 depicts a method whereby companies that have already been added to the equity index are reevaluated to determine whether they should continue to be included in the index. As described in further detail below, in the example reevaluation method 600 of FIG. 6, less exacting standards may be employed as compared to the initial evaluation methods of FIGS. 4 and 5, such that it may be more difficult to remove the particular company from the index after it has been placed there.

The reevaluation method of FIG. 6 may mirror the initial evaluation methods of FIGS. 4 and 5, except in the particular thresholds employed for the region of operation and liquidity determinations. Financial data associated with a plurality of companies may be stored in a financial data store 602. The plurality of companies may be those that have already been added to the equity index. At 604, the financial data store 602 may be used to access financial data for the particular company. At 606, a determination may be made using the accessed financial data as to whether the particular company does a threshold amount of business in the particular region. Threshold criteria 606a for the determination 606 may require that the particular company does more than 25% of its business in the particular region. By way of comparison, threshold criteria 506a of FIG. 5 requires that a particular company to be added to the index do more than 50% of its business in a particular region. Thus, the 25% requirement of threshold criteria 606a presents a lower standard, such that it may be easier for the particular company to stay in the index, even if the amount of business it does in the particular region drops. The lower standard of the threshold criteria 606a may be employed for a variety of purposes. For example, the lower standard may be used to help ensure stability of the index and/or to lower transaction costs associated with frequently removing companies from the index.

If the particular company does not do more than the threshold amount of business 606a in the particular region, the particular company may be discarded from the index at 608. If the particular company does more than the threshold amount of business 606a in the particular region, a determination may be made as to whether the particular company meets a predefined liquidity threshold at 610. The predefined liquidity threshold may be based on, for example, one or more of the following criteria factors 610a: whether the particular company's market capitalization is greater than a threshold value (e.g., $75 million U.S. dollars); whether the particular company's free-float market capitalization is in a particular free-float market capitalization range (e.g., within a 0% to 98% free-float market capitalization range); whether the particular company's free-float average is greater than a threshold value (e.g., greater than or equal to 5%); whether the particular company has a 3-month average daily trading volume greater than a threshold value (e.g., $0.6 million U.S. dollars for this and the previous two quarters); and whether the particular company has greater than a threshold value of shares traded per month for six months (e.g., 200,000 shares).

Criteria factors 610a for the liquidity threshold determination 610 may additionally specify that the particular company may undergo a revenue drop of up to 25% and still remain in the index. The liquidity threshold may be based on any combination of the criteria factors 610a, and in one example, all of the individual factors must be satisfied in order for the liquidity threshold to be met. In addition to the criteria factors 610a illustrated in FIG. 6, the criteria factors 610a may further require that the particular company have no more than ten non-trading days in a three-month period. In another example, the liquidity filter may also require that a company be associated with stock that is tradable by foreign investors. In yet another example, the liquidity filter may require that real-time and historic pricing be available for a security associated with the particular company. Similar to the threshold criteria 606a for the region determination 606, the criteria factors 610a for the liquidity threshold of the reevaluation method may be lower than those of the initial evaluation method of FIG. 5. If the particular company does not meet the criteria factors 610a for the liquidity threshold determination 610, the particular company may be discarded from the index at 612.

If the particular company does more than the threshold amount of business in the particular region 606a and meets the criteria factors 610a for the liquidity threshold, the particular company may be allowed to remain in the index at 614. The particular company may thus be placed in or allowed to remain in a data store 616 containing information for the selected companies. At 618, assigned weights for the companies in the index may be reevaluated. As in the initial evaluation process, the reevaluation of the assigned weights 618 may be based on market capitalizations for each of the selected companies. Following reevaluation of the assigned weights, an identification of the selected companies allowed to remain in the index and the reevaluated weights may be stored in an index data store 620.

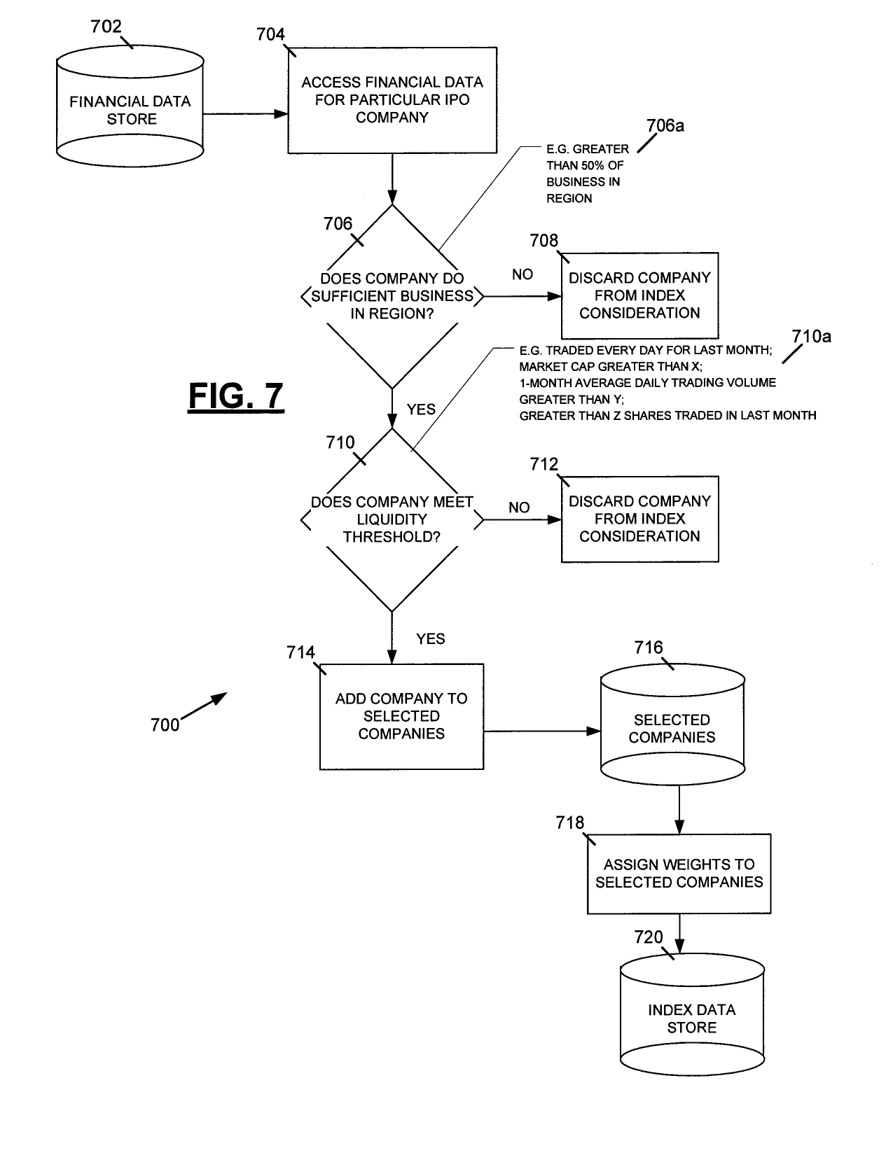

FIG. 7 is a flowchart 700 illustrating an initial public offering (IPO) fast track method for adding companies to an equity index associated with a particular geographic region. Pursuant to the IPO fast track method of FIG. 7, if a particular company has recently had its initial public offering or stock market launch, the particular company may be eligible to be added to the index if it meets certain criteria. The IPO fast track method may mirror the example methods of FIGS. 4-6 but may vary in the criteria applied to companies. Thus, financial data for a plurality of companies may be stored in financial data store 702, and at 704, financial data for the particular IPO company may be accessed from the data store 702. Determinations may be made as to whether the particular IPO company meets a regional requirement threshold 706 and a liquidity threshold 710, and if the particular IPO company fails either of these determinations, it may be discarded from further index consideration at 708, 712. If the particular IPO company passes the two thresholds 706, 710, it may be selected for inclusion in the index 714 and placed into a data store 716 containing other selected companies. At 718, weights may be assigned to the selected particular IPO company and other selected companies based on the companies' market capitalizations. The selected companies and the assigned weights may be placed in an index data store 720. The IPO fast track method 700 may be used to evaluate recent IPO companies on a quarterly basis.

As noted above, the IPO fast track method 700 may vary from the method typically employed for adding companies to the index only in the particular criteria that are applied in evaluating the companies. In FIG. 7, the example regional threshold criteria 706a may require that the particular company do more than 50% of its business in the region. Although this regional threshold criterion 706a may be the same as that of the non-IPO evaluation method of FIG. 5, a liquidity threshold 710a may be significantly modified in the IPO fast track method. In the example of FIG. 7, the liquidity threshold 710a may require that the following conditions are met: the particular IPO company has been traded every day during the past month; a full market capitalization value for the particular IPO company is greater than $150 million U.S. dollars; a 1-month average-daily-trading volume for the particular IPO company is greater than $1.0 million U.S. dollars; and the particular IPO company has had more than 250,000 shares traded in the past month. The liquidity threshold may be based on any combination of the criteria factors 710a, and in one example, all of the individual factors must be satisfied in order for the liquidity threshold to be met.

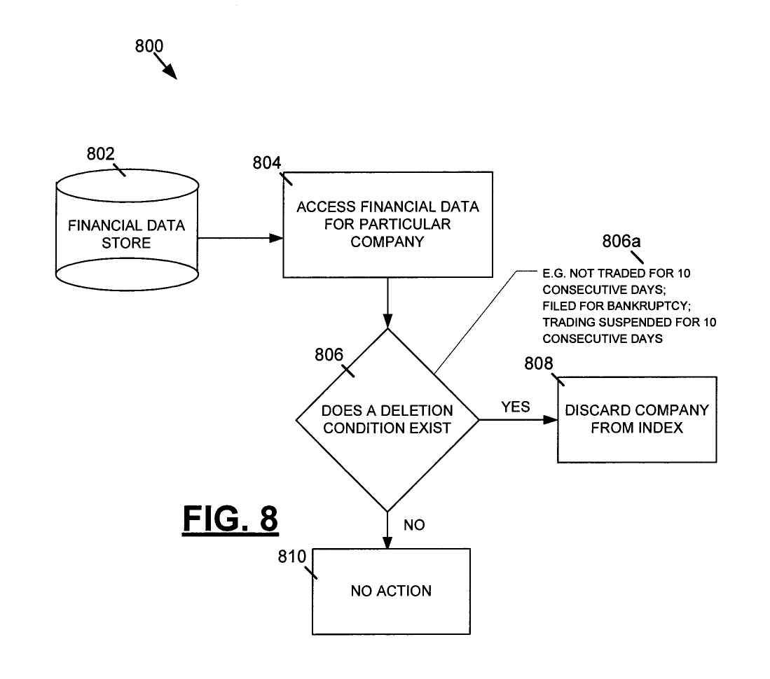

FIG. 8 is a flowchart 800 illustrating a method used to determine whether a particular company should be deleted immediately from a regional index. In one example, the particular company listed in the regional index may be reevaluated according to the reevaluation method of FIG. 6 on a quarterly basis. Thus, at points in time between the quarterly reviews, the company may fail to meet the region criterion or the liquidity threshold of FIG. 6 but may nevertheless be allowed to remain in the index at least until the next quarterly review. By contrast, the method of FIG. 8 may be used to evaluate companies listed in the regional index on a more frequent basis (i.e, daily, weekly), and if a deletion condition exists, a company may be deleted immediately from the index. This deletion may thus occur at times between the quarterly reviews.

In the flowchart of FIG. 8, at 804, financial data for the particular company may be accessed from a financial data store 802. At 806, using the accessed financial data, a determination may be made as to whether a deletion condition exists for the particular company. In one example, a deletion condition 806a may require that the particular company be immediately deleted from the index if it has not been traded for ten consecutive days. In another example, a deletion condition 806a may require that the particular company be immediately deleted from the index if it has been suspended from trading for ten consecutive days. In yet another example, a deletion condition 806a may require that the particular company be immediately deleted from the index if it has filed for bankruptcy. If a deletion condition exists, the particular company may be discarded immediately from the index at 808. If no deletion condition exists, no action is taken and the particular company may be allowed to remain in the index at 810.

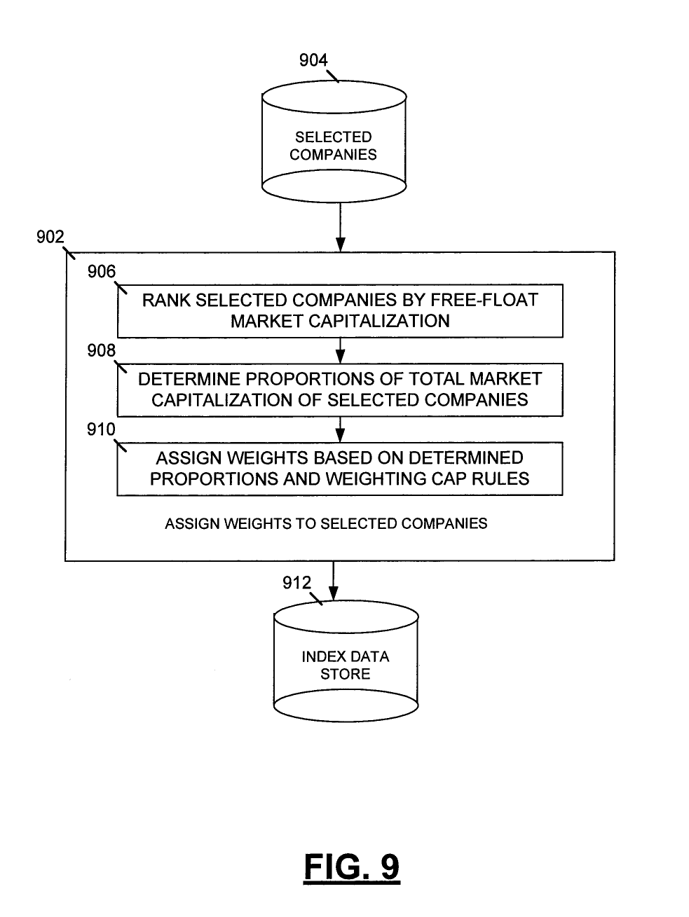

FIG. 9 is a flowchart depicting a method 902 of assigning weights to companies selected for an index. Financial data for the companies may be accessed from a data store 904 containing financial data associated with the selected companies. To assign the weights, at 906, the selected companies may be ranked based on the companies' free-float market capitalization values. At 908, a determination may be made as to each company's proportion of the total market capitalization of all selected companies. At 910, weights may be assigned to the selected companies based on the determined proportions and weighting cap rules (e.g., the weighting cap rules described above with respect to FIG. 3). After assigning the weights to the selected companies, an identification of the selected companies and their corresponding assigned weights may be stored in an index data store 912 (e.g., a non-transitory computer-readable medium).

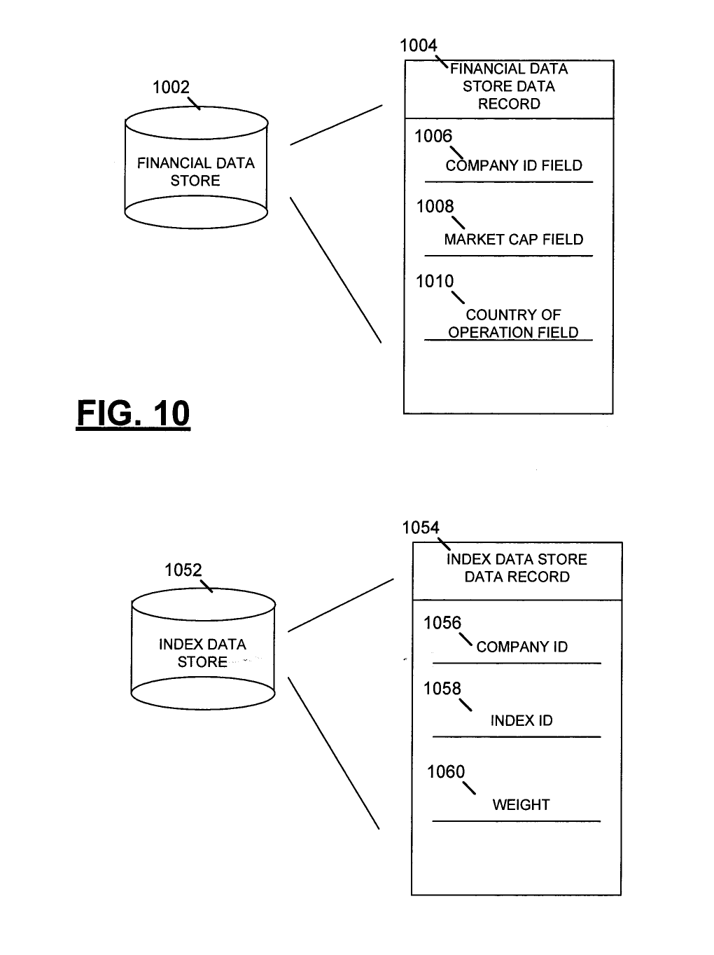

FIG. 10 depicts data structures 1004, 1054 used in a system for generating an equity index associated with a particular geographic region. A financial data store 1002 may be configured to store financial data records associated with a plurality of companies according to the financial data store data structure 1004. The financial data store data structure 1004 may include a company identification field 1006, a market capitalization field 1008, and a country of operation field 1010.

An index data store 1052 may be configured to store index data records associated with companies selected for inclusion in an index. The index data records may store data according to an index data structure 1054. The index data structure 1054 may include a company identification field 1056, an index identification field 1058, and an index weight field 1060. A particular index weight stored in the index weight field 1060 may be based on a market capitalization of a particular company and a total capitalization of all companies in the index.

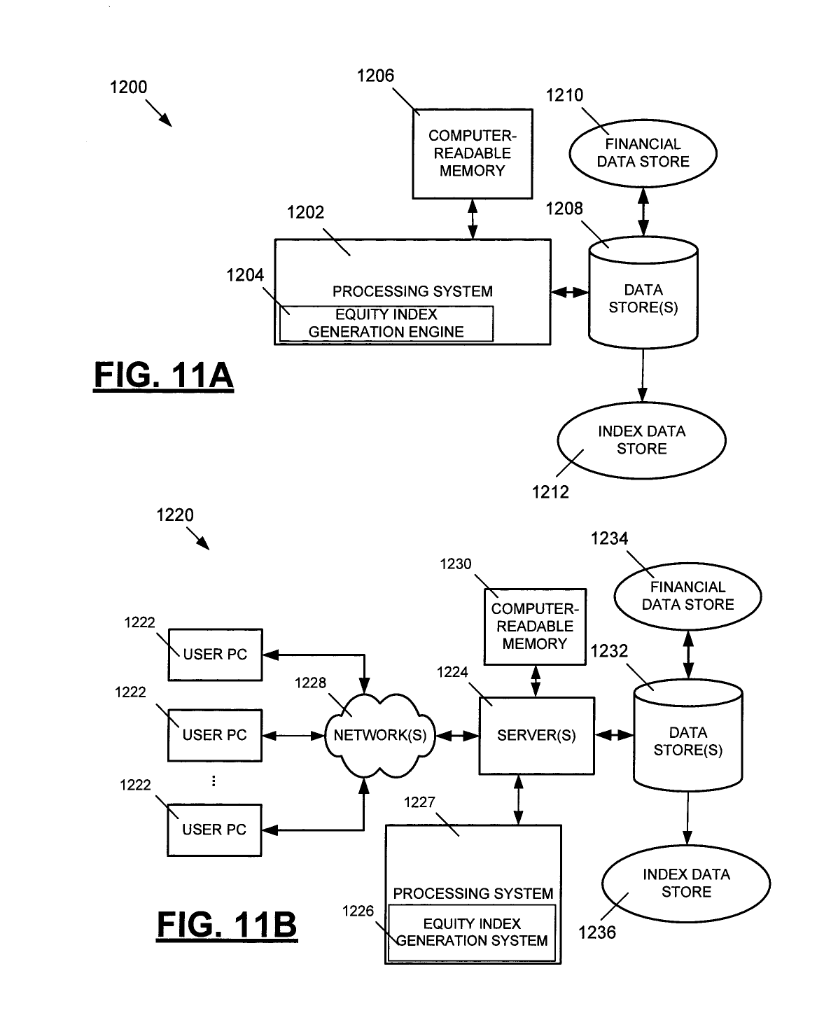

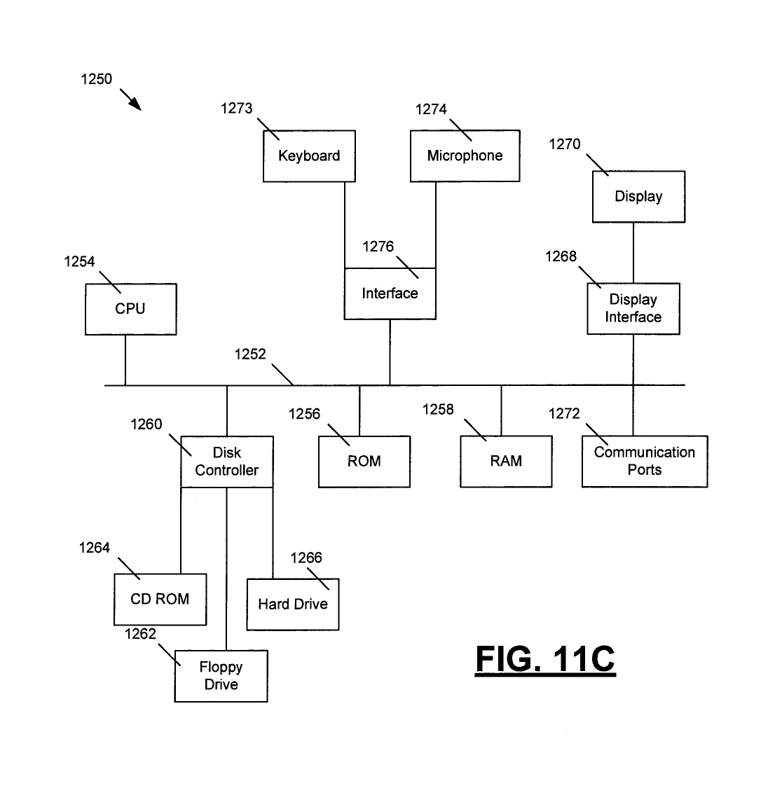

FIGS. 11A, 11B, and 11C depict example systems for use in implementing an equity index generation system. For example, FIG. 11A depicts an exemplary system 1200 that includes a standalone computer architecture where a processing system 1202 (e.g., one or more computer processors located in a given computer or in multiple computers that may be separate and distinct from one another) includes an equity index generation system 1204 being executed on it. The processing system 1202 has access to a computer-readable memory 1206 in addition to one or more data stores 1208. The one or more data stores 1208 may include financial data stores 1210 as well as index data stores 1212.

FIG. 11B depicts a system 1220 that includes a client server architecture. One or more user PCs 1222 access one or more servers 1224 running an equity index generation system 1226 on a processing system 1227 via one or more networks 1228. The one or more servers 1224 may access a computer readable memory 1230 as well as one or more data stores 1232. The one or more data stores 1232 may contain financial data stores 1234 as well as index data stores 1236.

FIG. 11C shows a block diagram of exemplary hardware for a standalone computer architecture 1250, such as the architecture depicted in FIG. 11A that may be used to contain and/or implement the program instructions of system embodiments of the present invention. A bus 1252 may serve as the information highway interconnecting the other illustrated components of the hardware. A processing system 1254 labeled CPU (central processing unit) (e.g., one or more computer processors at a given computer or at multiple computers), may perform calculations and logic operations required to execute a program. A non-transitory processor-readable storage medium, such as read only memory (ROM) 1256 and random access memory (RAM) 1258, may be in communication with the processing system 1254 and may contain one or more programming instructions for performing the method of generating a composite video. Optionally, program instructions may be stored on a non-transitory computer readable storage medium such as a magnetic disk, optical disk, recordable memory device, flash memory, or other physical storage medium.

A disk controller 1260 interfaces one or more optional disk drives to the system bus 1252. These disk drives may be external or internal floppy disk drives such as 1262, external or internal CD-ROM, CD-R, CD-RW or DVD drives such as 1264, or external or internal hard drives 1266. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1260, the ROM 1256 and/or the RAM 1258. Preferably, the processor 1254 may access each component as required.

A display interface 1268 may permit information from the bus 1252 to be displayed on a display 1270 in audio, graphic, or alphanumeric format. Communication with external devices may optionally occur using various communication ports 1272.

In addition to the standard computer-type components, the hardware may also include data input devices, such as a keyboard 1273, or other input device 1274, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive of” may be used to indicate situations where only the disjunctive meaning may apply.

1. A computer-implemented method of generating an equity index associated with a particular geographic region, comprising:
storing financial data associated with a plurality of companies in a non-transitory computer-readable medium, wherein the financial data identifies a country of operation and a market capitalization value;
determining whether a particular one of the companies does more than a threshold amount of business in a particular geographic region using the financial data using one or more data processors;
using historical trading data for the particular company to determine whether the particular company meets a predefined liquidity threshold using the one or more data processors, wherein the predefined liquidity threshold requires a minimum average trading volume or a minimum number of securities traded over a particular period of time;
selecting the particular company for the index when the company does more than the threshold amount of business in the particular geographic region and the company meets the predefined liquidity threshold using the one or more data processors;
assigning a weight to the selected particular company and other selected companies based on free float market capitalizations from the financial data using the one or more data processors, wherein the weights for the particular company and the other selected companies are capped; and
storing an identification of the selected particular company and the other selected companies and the assigned weights in the non-transitory computer-readable medium.

2. The method of claim 1, further comprising:
determining a proportion of business of the particular company associated with the particular geographic region;
wherein the determination of whether the particular company does more than the threshold amount of business in the particular region is based on the determined portion of business.

3. The method of claim 1, wherein the threshold amount of business is 50%.

4. The method of claim 1, whether the particular company does more than the threshold amount of business is based on a source of revenues, where the particular company is listed for trading, a location of incorporation or organization of the company, or a location of a property.

5. The method of claim 1, wherein the predefined liquidity threshold requires that the particular company be associated with stock that is tradable by foreign investors.

6. The method of claim 1, wherein the predefined liquidity threshold requires that real-time and historic pricing be available for a security associated with the particular company.

7. The method of claim 1, wherein the predefined liquidity threshold requires that a security associated with the particular company has no more than ten non-trading days in the last three month or 90 day period.

8. (canceled)

9. The method of claim 1, wherein the predefined liquidity threshold requires a minimum average-daily-trading volume greater than $1 million U.S. dollars for the current and previous two quarters, or the predefined liquidity threshold requires greater than 250,000 securities associated with the particular company have been traded per month over the past six months at the current and end of previous two quarters.

10. The method of claim 1, further comprising:
applying an additional filter to the plurality of companies, wherein a filtered company is excluded from the index despite meeting the amount of business and predefined liquidity thresholds.

11. The method of claim 1, wherein the additional filter is one of:
a filter requires that the market capitalization value for the company be greater than a market capitalization threshold;
a filter requires that the market capitalization value for the company be greater than $150 million U.S. dollars;
a filter that requires a predefined free-float market capitalization range;
a filter that requires a free-float market capitalization range of 0% to 85%;
a filter that requires a predefined free-float market capitalization minimum; and
a filter that requires a predefined free-float market capitalization minimum of at least 10%.

12. The method of claim 1, further comprising:
performing a quarterly review of the identified companies of the index by applying a test to the identified companies; and
removing companies that fail the test from the index.

13. The method of claim 12, wherein the test is based on market capitalization values or liquidity measurements of the identified companies.

14. The method of claim 12, wherein passing the test requires:
that an identified company has a market capitalization value of greater than $75 million U.S. dollars;
that the identified company be within a 0% to 98% free-float market capitalization range;
that the identified company has a free-float of at least 5%;
that the three month average-daily-trading volume of a security associated with the identified company be greater than $0.6 million U.S. dollars for the current and previous two quarters; and
that greater than 200,000 units of a security associated with the identified company have been traded per month in the past six-months at this and one of the previous two quarters.

15. (canceled)

16. The method of claim 1, wherein the weights are capped according to:
a maximum 8.0% weight for any single company;
when market capitalization of each of a largest two companies exceed 8.0% of total market capitalization of all companies of the index, weights for the largest two companies are capped at 8.0%;
when third largest company exceeds 7.0%, a weight for the third largest company is capped at 7.0%;
when fourth largest company exceeds 6.5%, a weight for the fourth largest company is capped at 6.5%;
when fifth largest company exceeds 6.0%, a weight for the fifth largest company is capped at 7.0%;
when sixth largest company exceeds 5.5%, a weight for the sixth largest company is capped at 7.0%;
when seventh largest company exceeds 5.0%, a weight for the seventh largest company is capped at 7.0%; and
when any other company exceeds 4.5%, a weight for the any other company is capped at 4.5%.

17. The method of claim 1, wherein a weight for a company selected for the index that is incorporated or listed for trading outside of the particular geographic region is capped at 4.5%.

18. The method of claim 1, further comprising:
removing a company from the index when that company meets a removal criteria.

19. The method of claim 1, further comprising:
adding a company associated with an initial public offering to the index when that company meets an initial public offering criteria.

20. A computer-implemented method of generating an equity index associated with a particular geographic region, comprising:
storing financial data associated with a plurality of companies in a non-transitory computer-readable medium, wherein the financial data identifies a country of operation and a market capitalization value;
determining whether a particular one of the companies does more than a threshold amount of business in a particular geographic region using the financial data using one or more data processors;
using historical trading data for the particular company to determine whether the particular company meets a predefined liquidity threshold using the one or more data processors;
selecting the particular company for the index when the company does more than the threshold amount of business in the particular geographic region and the company meets the predefined liquidity threshold using the one or more data processors;
assigning a weight to the selected particular company and other selected companies based on free float market capitalizations from the financial data using the one or more data processors; and
storing an identification of the selected particular company and the other selected companies and the assigned weights in the non-transitory computer-readable medium; and
providing a value for the index according to:
Index Value=Σ_{i=1 to n}pᵢ×qᵢ×ffᵢ×fxᵢ×cfᵢ
wherein pᵢ is a stock price for a company in the index;
wherein qᵢ is a number of shares in the index;
wherein ffᵢ is a free-float factor for a company in the index;
wherein fxᵢ is an exchange rate; and
wherein cfᵢ is a weighting cap factor.

21. The method of claim 1, wherein at least 20 companies are selected for the index.

22. The method of claim 1, further comprising:
purchasing shares of the selected companies; and
offering to sell shares of the index for an index price that is based on prices of the shares of the selected companies;
receiving money for purchase of a share of the index; and
transferring the share of the index in exchange for the received money.

23. The method of claim 1, wherein the geographic region is a country or a continent.

24. The method of claim 1, further comprising:
selecting the particular company for the index when the company is incorporated or otherwise organized in the particular geographic region and the company meets the predefined liquidity threshold.

25. A system for generating an equity index associated with a particular geographic region, comprising:
one or more data processors;
one or more non-transitory computer-readable mediums responsive to the one or more data processors, wherein the one or more computer-readable mediums include:
a financial data store, wherein the financial data store is configured to store financial data records associated with a plurality of companies according to a financial data store data structure, wherein the financial data store data structure includes:
a company identification field;
a market capitalization field;
a country of operation field; and
an index data store, wherein the index data store is configured to store index data records associated with companies selected for inclusion in an index, wherein the companies selected for inclusion in the index do more than a threshold amount of business in a particular geographic region, as determined by the financial data records, wherein the companies selected for inclusion in the index meet a predefined liquidity threshold that requires a minimum average trading volume or a minimum number of securities traded over a particular period of time, and wherein the index data records store data according to an index data structure that includes:
a company identification field;
an index identification field; and
and an index weight field, wherein a particular index weight is based on a market capitalization of a particular company and a total market capitalization of all companies in the index, wherein weights for the particular company and each other company in the index are capped.

26. The system of claim 25, wherein the one or more computer-readable mediums further include instructions for commanding the one or more data processors to execute steps that include:
determining whether the particular company does more than a threshold amount of business in the particular geographic region using the financial data store;
using historical trading data for the particular company to determine whether the particular company meets the predefined liquidity threshold;
selecting the particular company for the index when the company does more than the threshold amount of business in the particular geographic region and the company meets the predefined liquidity threshold;
assigning an index weight to the selected particular company and other selected companies based on market capitalizations from the financial data; and
storing the assigned weights in the index data store.
